(19) United States
(12) Patent Application Publication
(10) Pub. No.: US 2008/0310870 A1
(43) Pub. Date: Dec. 18, 2008

(54) Method for Developing Potential Images Which are Produced on an Intermediate Image Carrier of Images Which are to be Printed Having Selectable Customer-Specific Colors in an Electrographic Printing or Copying Device

(76) Inventors: Martin Berg, Munchen (DE); Volkhard Maess, Pilening (DE)

Correspondence Address: SCHIFF HARDIN, LLP;PATENT DEPARTMENT, 6600 SEARS TOWER, CHICAGO, IL, 60606-6473, US

(21) Appl. No.: 12/097,076

(22) PCT Filed: Jan. 4, 2007
(86) PCT No.: PCT/EP2007/050065

§ 371 Date: Jun. 12, 2008

(30) Foreign Application Priority Data
Jan. 12, 2006 (DE) 10 2006 001 648.3

(51) Int. Cl. G03G 15/01; G03G 15/10

(52) U.S. Cl. 399/54

(57) ABSTRACT

In a method or system to develop a potential image with selectable customer-specific colors using a developer fluid in an electrographic printing or copying device, a customer-specific color for print job is generated as a developer fluid from primary color concentrates and a carrier fluid in a mixing container of a mixing device. The developer fluid is fed to a developer station to develop the potential images. Given a color change to a new color in a mixing device, color values of a color of a residual developer fluid that remains are measured and via comparison of these color values with color values of the new color it is determined whether the new color can be generated using the residual developer fluid. If this is the case, the residual developer fluid is used to generate the new color. If it is not the case, a fill level in the mixing container is first reduced to a residual quantity at a lower limit of the tolerance range for sufficient inking for a following print job by adding fluid, and this residual quantity is used to generate the new color.

### BACKGROUND

For single- or multi-color printing of a recording medium (for example a single sheet or a belt-shaped recording medium) made of the most varied materials (for example paper or thin plastic or metal films) it is known to generate image-dependent potential images (charge images) on an intermediate image carrier (for example a photoconductor), which potential images correspond to the images (comprised of regions that are to be inked and regions that are not to be inked) to be printed. The regions of the potential images that are to be inked are made visible via toner with a developer stream (inking station). The toner image is subsequently transfer-printed onto the recording medium.

Toner particles and carrier fluid containing developer fluid can thereby be used to ink the potential images.

A method for electrophoretic fluid developing (electrographic developing) in digital printing systems is known from WO 2005/013013 A2, for example. A carrier fluid containing silicone oil with color particles (toner particles) dispersed therein is thereby used as a developer fluid. More in this regard can be learned from WO 2005/013013 A2, which is a component of the disclosure of the present application.

U.S. Pat. No. 6,526,244 B1 discloses a developer station with which customer-specific colors can be generated. For this a mixing device according to FIG. 3 is provided in which primary color concentrates (selectable from color toner and carrier fluid) situated in a container can be mixed into customer-specific colors (developer fluid). This developer fluid is supplied to the developer station and there is used to develop the charge images on a photoconductor. The remaining developer fluid after the development of the charge images is returned to the container or a residual container. The developer station and the mixing device are automatically cleaned with the aid of the carrier fluid before a color change should be implemented.

EP 0 833 219 A1 describes a color mixing system for an electrographic printing device in order to be able to print customer-specific colors. Primary color concentrates are extracted from containers corresponding to the customer-specific color and blended in a mixing container. The customer-specific color is used to develop the charge images on a photoconductor.

A copier with which different colors can be printed results from DE 36 23 251 C2. If a color change is required, at least the developer station must be cleaned. For this the developer fluid is used for black. This is conveyed by the developer station, then the system waits until the developer fluid for black has drained. The developer fluid for the next color is subsequently supplied to the developer station. The emptying of the developer station occurs via gravity.

US 2003/103 775 A1 concerns a method with which it can be established whether a color used in printing that has been contaminated must be replaced. Given color printing, contamination is achieved in that color toner is transported over the photoconductor to adjacently situated developer stations.

### SUMMARY

It is an object to specify a device and a method with which customer-specific colors can be generated corresponding to a print job of the customer and a color change is possible without exchanging system components (for example the developer station).

In a method or system to develop a potential image with selectable customer-specific colors using a developer fluid in an electrographic printing or copying device, a customer-specific color for print job is generated as a developer fluid from primary color concentrates and a carrier fluid in a mixing container of a mixing device. The developer fluid is fed to a developer station to develop the potential images. Given a color change to a new color in a mixing device, color values of a color of a residual developer fluid that remains are measured and via comparison of these color values with color values of the new color it is determined whether the new color can be generated using the residual developer fluid. If this is the case, the residual developer fluid is used to generate the new color. If it is not the case, a fill level in the mixing container is first reduced to a residual quantity at a lower limit of the tolerance range for sufficient inking for a following print job by adding fluid, and this residual quantity is used to generate the new color.

### BRIEF DESCRIPTION OF THE DRAWINGS

FIG. 1 illustrates a design of the device of the preferred embodiment; and

FIG. 2 illustrates a workflow diagram that represents a mode of operation of the device of FIG. 1.

### DESCRIPTION OF THE PREFERRED EMBODIMENTS

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The device of the preferred embodiment for developing potential images generated on an intermediate image carrier with colors selectable by the customer using a developer fluid possessing charged toner particles and carrier fluid provides a mixing device
that, dependent on the selectable color, possesses respective primary color concentrates with charged colorant toner particles in reservoirs and a reservoir with carrier fluid, and
that possesses a mixing station connected with the reservoirs, in which mixing station the developer fluid associated with the selected, customer-specific color is generated from the primary color concentrates and the carrier fluid.

The mixing device is connected with a developer station to which the developer fluid is supplied and that develops the potential images on the intermediate image carrier in the previously generated customer-specific color. The residual developer fluid remaining in the developer station after conclusion of a print job is supplied to a receiving device that receives these.

Reservoirs with primary color concentrates for 2 to 15 colors (advantageously 4 to 7 colors) can be provided for a large selection of colors. The primary color concentrates can thereby possess the same carrier fluid and contain a large proportion by weight of colorant toner particles, advantageously 10 to 55%. The color locations of the colorant toner particles can be selected such that the primary color concentrates exhibit a high chroma (saturation) and a graduated color angle (hue).

The mixing station can possess a mixing container and a mixing unit (for example a rotor) in order to generate the customer-specific developer fluid. If an evaluation device for calorimetric evaluation of the developer fluid is arranged at the output of the mixing station, the developer fluid can be checked as to whether the mixed color corresponds to the customer request, and if necessary corrections can be made.

In order to be able to adapt the quantity of the color to be mixed to the respective customer request, a means to determine the fill level in the mixing container can be provided in the mixing station. The means can be a fill level sensor or a weight sensor.

In addition to a sensor for colorimetric evaluation of the developer fluid, the evaluation device controlled by a control unit can additionally [sic] possess a sensor to determine the proportion of colorant toner particles in the developer fluid. It is then possible to adjust the proportion of colorant toner particles.

In order to be able to extract the developer fluid from the developer station, it is appropriate when this can be pivoted from the intermediate image carrier. It is additionally advantageous if the transfer path for the developer fluid in the developer station is designed such that the developer fluid located in the developer station can be emptied into the receiver device.

When a drain for the developer fluid is arranged in the lower region of the developer station, the emptying of the developer station can occur as a result of gravity after pivoting the entire developer station or parts of the developer station. However, the emptying of the developer station can also be implemented with the aid of a transport system. It is appropriate when the developer station possesses a receptacle for the portion of developer fluid (residual developer fluid) not used in the development of the potential images, which receptacle is connected with the acquisition device.

To forward the residual developer fluid from the receptacle to the receiver device, a first 2-way valve can be arranged at its input, via which first 2-way valve a connection with the mixing station or (via a second 2-way valve) with a filter station or a residual container can be established. The filter station can be connected with the mixing station such that the residual developer fluid can be used as well in the generation of the developer fluid of the next color.

It is advantageous when the regions of the connection system (connections between mixing device, developer station, receiver device and transfer paths for the developer fluid within the mixing device, developer station, receiver device) for the developer fluid in which an emptying via gravity or the transport system is not possess sufficient anti-adhesive properties. Then no residues of developer fluid can remain in the connection system when the color is changed. It is additionally advantageous when the connection system is designed such that no regions without flow exist in operation of the device and thus a regular exchange of the developer fluid with the entire circuit exists. Furthermore, the connection system can be designed such that no discontinuous changes of the flow cross-sections in the connections are present or that the changes of the flow cross-sections of the connections are such that no reversal of the flow direction can occur, only a change of the flow speed.

A fluid that is identical to the carrier fluid can be used to clean the connection system, the mixing device and the developer station. It is then possible that given use of a developer fluid with a new color this can possibly be mixed with residues of the previous developer fluid.

The developer station can be designed in a known manner. An advantageous realization of the developer station can possess a feed device, an applicator device and a cleaning device. The feed device can then be connected with the mixing device to accept the developer fluid. The developer fluid can be transferred from the feed device onto the applicator device and be directed from this past the intermediate image carrier. The cleaning device can clean the residual developer fluid remaining in the applicator device after the development of the potential images off of the applicator device and dispense the residual developer fluid into the receptacle.

An appropriate design of the feed device can possess a chamber blade and a raster roller, wherein the chamber blades possess an inflow and an overflow, and the inflow is connected with the mixing device and the overflow is connected with the receptacle. The developer fluid can then pass from the raster roller onto the applicator device (for example an applicator roller).

An advantageous realization of the cleaning device can possess a cleaning roller that accepts the residual developer fluid from applicator device and on which a cleaning blade rests that strips the residual developer fluid off from the cleaning roller and supplies it to the receptacle.

To avoid waste it is advantageous when the color of the developer fluid is respectively calorimetrically determined in the mixing device and whether the developer fluid of the new color can be generated using the residual developer fluid of the previously printed color is determined promptly before a color change. In order to accelerate this method, given printing of multiple colors the different colors to be printed can be organized in the printing order such that an optimal reusability of the residual developer fluid of a print job is possible in the next print job.

The device is thereby designed such that upon changing a color to be printed, this can be cleaned without user interaction, even if the residual developer fluid of the previous print job cannot be used in the generation of the color of the next print job. In this case, before the mixing of the developer fluid for the following print job the fill level of the developer fluid of the running print job in the mixing container and possibly the concentration of the colorant toner particles in the mixing container are reduced to the lower limit of the tolerance range for a sufficient coloring of the developer fluid for the following print job.

The suitability of the residual developer fluid as a mixture component for the developer fluid with the coloring of the following print job can be assumed when the generation of the color of the following print job is possible with the existing primary color concentrates. Criteria can be that the chroma (saturation) of the color is greater than or equal to that of the color of the next print job and the color angle (hue) is between or sufficiently close to the color angles of adjacent primary colors of the next print job.

Given unsuitability of the residual developer fluid as a mixture component of the color for the next print job, this can be conveyed into the residual container. Its fill level can be monitored in order to ensure a timely emptying.

The cleaning of the developer station can be implemented after it has been established whether the residual quantity of developer fluid can be used for the color of the next print job, wherein the carrier fluid is appropriately used as a cleaning fluid. The developer station is thereby not in contact with the intermediate image carrier. In a first cleaning operation the cleaning fluid can be conveyed through the mixing device and the developer station and then be returned again to the mixing device. In further cleaning operations components of the developer station can be supplied with cleaning fluid and can be operated separately from the other components, wherein the separately operated components can be operated in reverse in the rotation or transport direction. As separately operated components, the cleaning fluid can be supplied to the applicator roller or the feed device (in particular the chamber blade and the raster roller) can be operated separately with the cleaning fluid.

In the cleaning a filter station can be used to separate the colorant toner particles in order to deplete the residual developer fluid of colorant toner particles. The separation can occur with the aid of an electrical field or a sieve can be used. Finally, a centrifuge can also be used to deposit the colorant toner particles.

The cleaning of the developer station can occur in a cyclical process in which a steady reduction of the concentration of the colorant toner particles occurs in the developer fluid located in the mixing container and the developer station. The concentration limit of the colorant toner particles until which the cyclical cleaning process lasts can thereby be defined in that a color shift according to the CIELAB system of ΔE<3 occurs at this concentration for the subsequent customer-specific color.

The particular advantages of the device and of the method are visible in the following features:
the color change takes a short time, advantageously less than 5 minutes;
the color change ensues automatically—no user intervention is required;
the use of a method with colorimetric determination of the mixture color enables the use of the residual developer fluid of the preceding print job as a mixture component for the developer fluid of the next print job;
the use of a print job management that organizes the print jobs such that an optimal reusability of the residual developer fluids is enabled;
the use of an integrated cleaning system (cleaning with carrier fluid, design of the developer station, filter system) makes it possible that the change from one customer-specific color to the next can occur without user intervention, even when the residual developer fluid cannot be used as a mixture component for the developer fluid of the next print job;
no exchange of the complete developer station for a reserve developer station is required upon changing a customer-specific color.

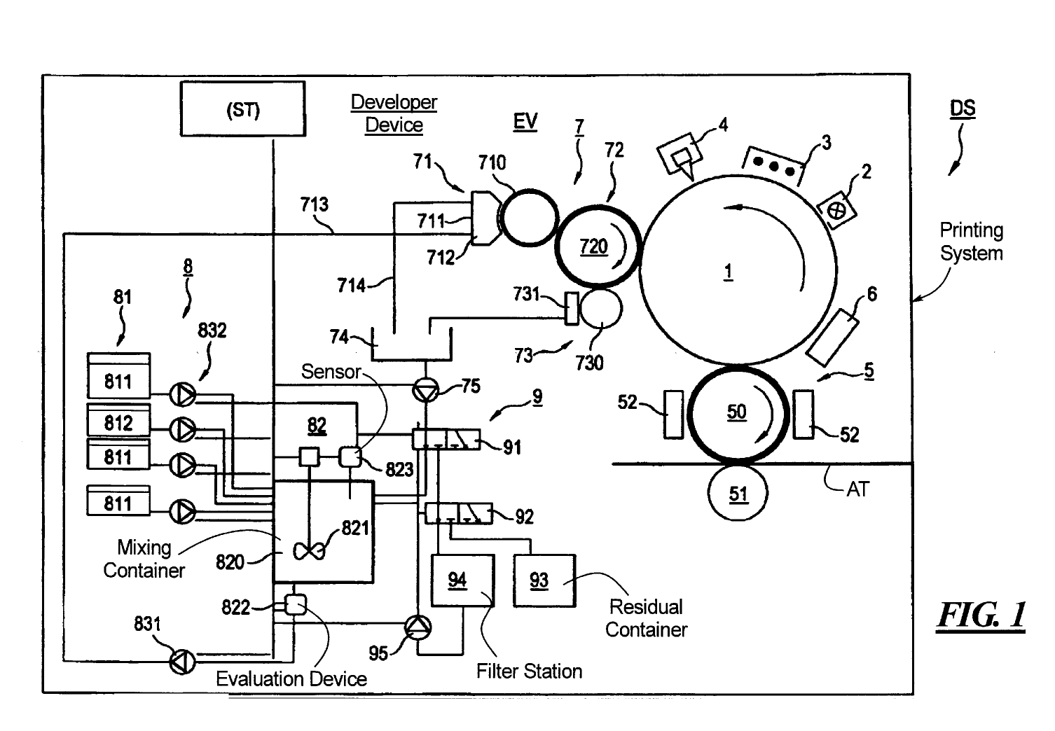

FIG. 1 shows the components of a printing system DS as it is known from WO 2005/013013 A2, for example; this is herewith incorporated into the disclosure. Arranged along an intermediate image carrier 1 (a photoconductor drum in FIG. 1) are a regeneration exposure 2; a charging station 3; an element 4 for graphical exposure; a developer device EV (inking station); a transfer unit 5 for transfer printing of the developed potential images onto a recording medium AT; an element 6 for cleaning the photoconductor drum. The transfer unit 5 possesses an elastic transfer roller 50, a counter-pressure roller 51 and a cleaning unit 52.

Of the components listed in FIG. 1 and arranged along the photoconductor drum, the developer device EV is discussed in detail in the following; the design and the function of the remaining components is known and can be learned from WO 2005/013013 A2, for example.

The developer device EV possesses: a developer station 7 for development of the potential images on the intermediate image carrier 1; a mixing device 8 for generation of the customer-specific color; and a receiving device to receive the remaining residual developer fluid upon completion of a print job. The developer station 7 for its part contains a feed device 71, an applicator device 72, a cleaning device 73 and a receptacle 74. The mixing device 8 possesses at least reservoir 81 for the primary color concentrates and a mixing station 82 for mixing of the developer fluid. The receiver station 9 contains means in order to process the residual developer fluid.

The applicator device 72 can be an applicator roller 720 or a developer belt which is arranged in contact with the intermediate image carrier 1. In the following an applicator roller 720 is discussed in the explanation without limiting the invention to this. The potential images on the intermediate image carrier 1 are developed with the applicator roller 720. For this the applicator roller 720 feeds a developer fluid (made up of at least a carrier fluid and charged colorant toner particles) to the intermediate image carrier 1. The development occurs in a known manner (WO 2005/013013 A2).

The developer fluid is conducted to the applicator roller 720 by a feed device 71. Said feed device 71 possesses a raster roller 710 with cups and webs and a chamber blade 711 arranged on the raster roller 710. The chamber blade 711 consists of at least one chamber 712, an inflow 713 and an overflow 714. The chamber blade 711 according to FIG. 1 is described in terms of its function in WO 2005/013013 A2. The developer fluid is extracted from the mixing device 8 and, for example, fed to the chamber blade 711 by a first pump 831. The remaining developer fluid in the chamber 712 is conducted via the overflow 714 into a receptacle 74, and from there the developer fluid can be pumped into the receiver device 8 with the aid of a further pump 75.

The applicator roller 720 is cleaned by the cleaning device 73 of residual developer fluid remaining upon the development of the potential images on the intermediate image carrier 1. For this it possesses, for example, a cleaning roller 730 resting on the applicator roller 720 and a cleaning blade 731 resting on the cleaning roller 730. The cleaning blade 731 strips the residual developer fluid from the cleaning roller 730 and feeds it to the receptacle 74.

The mixing device 8 is explained further in the following. This has a set of primary color concentrates in reservoirs 811, wherein the primary color concentrates contain the carrier fluid and the colorant toner particles dispersed therein. The number of different primary color concentrates can be between 2 to 15, advantageously 4 to 7. The proportion of colorant toner particles by weight is selected as high as possible; it should be between 10 to 55% of the respective primary color concentrate. It is advantageous when the color locations of the colorant toner particles exhibit a high chroma (saturation) and a graduated color angle (hue). A reservoir 812 is additionally provided for the carrier fluid.

The reservoir 811 with the primary color concentrates and the reservoir 812 with the carrier fluid are connected with a mixing station 82 via pumps 832. The mixing station 82 possesses a mixing container 820 with a mixing unit 821 and an evaluation device 822 at the outlet. The reservoir 811 for the primary color concentrate and the container 812 for the carrier fluid can be connected with the mixing container 820 via the pumps 832 depending on the selected color. There they are blended with the developer fluid by the mixing unit 821 (for example a rotor). A device 823 to determine its fill level can be provided in the mixing container 820, for example a fill level sensor (ultrasound sensor or capacitive sensor) or a weight sensor, in order to be able to determine the quantity of the produced developer fluid. With the evaluation device 822 at the outlet of the mixing container 820, the properties of the developer fluid can be checked with a sensor for colorimetric evaluation of the developer fluid and a sensor to determine the proportion of colorant toner particles in the developer fluid.

The outlet of the evaluation device 822 is connected via the circulating pump 831 with the inlet 713 of the chamber blade 710 in order to feed the developer fluid with the selected color to said chamber blade 710. With this the potential images on the intermediate image carrier 1 are then developed in the manner described above.

The residual developer fluid remaining after the development of the potential images is fed to the receptacle 74. The receptacle 74 is connected via the pump 75 with the first 2-way valve 91 via which the receptacle 74 can be connected with the mixing container 820 or with a second 2-way valve 92. Via this the residual developer fluid can be fed to a residual container 93 or a filter station 94. The filter station 94 is finally connected via a pump 95 with the mixing container 820. The residual developer fluid can thus be fed via the 2-way valves 91, 92 to the mixing container 820 directly or via the filter station 94 or be conducted into the residual container 93.

The connections for the developer fluid between the mixing device 8, the developer station 7 and the receiver device 9 and the transfer paths for the developer fluid within the mixing device 8, the developer station 7 and the receiver device 9 form a connection system for the developer fluid. The connections between the mixing device 8, the developer station 7 and the receiver device 9 can be realized via hoses, for example.

The developer station 7 is executed such that it can be automatically pivoted to and from the intermediate image carrier 1. The rollers (raster roller 711, applicator roller 720, cleaning roller 730) can likewise be automatically pivoted away from one another or, respectively, pivoted onto one another. The rotation direction of the rollers (raster roller 711, applicator roller 720, cleaning roller 730) can additionally be reversed. The developer station 7 is thereby executed such that the developer fluid can be completely conveyed out of the developer station 7, either by means of gravity after pivoting of the developer station 7 or parts thereof or by means of suction of the developer fluid from the developer station 7 via a transport system, for example by pumps that also transport developer fluid given partial air in the transport system.

In order to further improve the emptying of the connection system, the points of the connection system that cannot by emptied by gravity can be executed in an anti-adhesive manner in order to de-wet these points as well as to avoid solid accumulations (in particular colorant toner particles) and therefore to enable the drainage of the developer fluid. The connection system is furthermore designed such that upon operation no regions exist without flow and thus a continuous exchange of developer fluid with the total circuit is present. Finally, the connection system is executed such that no discontinuous changes of the flow cross-sections are present, or the changes in the flow cross-section are such that no reversal of the flow direction occurs, rather only a change of the flow speed. The carrier fluid can appropriately be used for cleaning of the connection system.

In the print operation, depending on the color to be printed according to the print job the corresponding reservoirs 811, 812 are connected with the mixing container 820 and the color developer fluid is generated. The fill level in the mixing container 820 is adapted via the fill level regulator to the required quantity of customer-specific color of the running print job. After the customer-specific developer fluid has been generated, this is fed to the developer station 7 which develops the potential images on the intermediate image carrier in a known manner.

If a new print job with a new color should be processed, it is initially checked whether the residual developer fluid can be used as well in the new print job. If this is not the case, the fill level in the mixing container 820 (and accordingly also the concentration of the colorant toner particles) is reduced to the lower limit of the tolerance range for a sufficient inking in the next print job, whereupon a waste minimization is achieved.

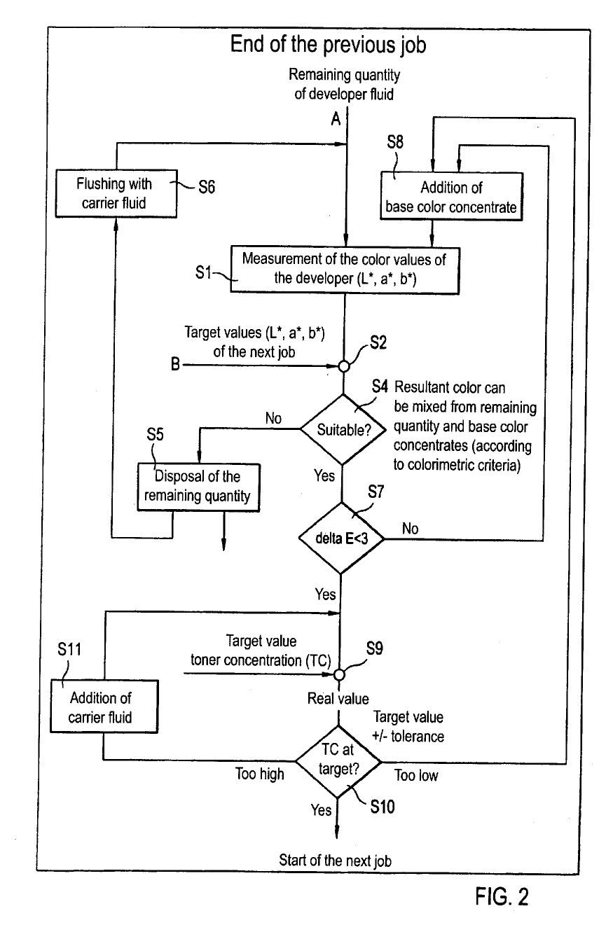

The workflow of the color mixing method is explained using the workflow diagram of FIG. 2.

Upon color change (to print job B) after conclusion of a print job (print job A), the minimized residual developer fluid is initially calorimetrically measured (Step S1) by determining the values L*, a*, b* (L*=brightness; a*=green-red coordinate; b*=blue-yellow coordinate according to the CIELAB color space) of the concluded print job (A). Suitability criteria are, upon comparison, higher or equal chroma, color angle (hue) between or sufficiently close to the color angles of adjacent primary colors of the customer job B (Δh<60°). The target values L*, a*, b* of the next print job B are subsequently input (Step S2) and these are compared (Step S3) with those of the preceding print job in order to establish whether the developer fluid with the color of the next print job B can be mixed from the residual quantity of the print job A and the primary color concentrates of the print job B (according to calorimetric criteria; Step S4).
If this is not the case, the residual quantity is removed as waste (residual container 93) in Step 92 and the device is flushed with coil group (Step S6). The developer station 7 is thereby not in contact with the intermediate image carrier 1. In a first cleaning operation the cleaning fluid can be conveyed through the mixing station 82 and the developer station 7 as in the printing operation and can be returned again to the mixing station 92. In a second cleaning operation, only components of the developer station 7 are supplied with cleaning fluid and are operated separately from the remaining developer station. These components can thereby be operated in reverse of the rotation and/or transport direction. The applicator roller 720 or the feed device (thus the chamber blade 711 and the raster roller 710) can be used as examples of separately operated components. After one or more circulations, the cleaning fluid can be directed through a filter station 94 to separate the colorant toner particles, wherein an electrical field effect or a sieve or a centrifuge can be used for separation. A continuous reduction of the concentration of the colorant toner particles in the residual fluid located in the mixing container 820 and developer station 7 thereby occurs. The concentration limit up to which the cyclical cleaning process lasts can be defined in that a color shift of ΔE<3 exists at this concentration in comparison to the color of the customer job B.

If this is the case (Step S4), the color of the print job B can be mixed from the residual quantity of the print job A and the primary color concentrates of the print job B. In step S7 it is examined whether a color shift of ΔE<3 (according to the CIELAB system) is thereby present for the color of the print job B. If ΔE<3 is not satisfied, the primary color concentrates of the print job B can be fed (Step S8) to the residual quantity of the print job A. The steps S1 and the following are subsequently executed. If ΔE<3 is satisfied, in Step S9 the target value of the concentration of the colorant toner particles is input and in Step S10 it is checked whether this target value is reached. If the target value is reached, the mixing method is ended. If the concentration of the colorant toner particles is too high, in Step S11 carrier fluid is added and Steps S9, S10 are subsequently repeated. Contrarily, if the concentration of colorant toner particles is too low, the workflow returns back to Step S8.

The depicted workflow is coordinated by a control unit ST that can be realized as a microprocessor that is programmed corresponding to the workflow diagram. The control lines to the individual components of the device are plotted in FIG. 2.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1-45. (canceled)

46. A method to develop a potential image of an image to be printed with selectable customer-specific colors using a developer fluid having charged toner particles and carrier fluid in an electrographic printing or copying device, the potential image being generated on an intermediate image carrier, comprising the steps of:
generating a customer-specific color for a print job as a developer fluid from primary color concentrates and a carrier fluid in a mixing container of a mixing device;
feeding the developer fluid to a developer station that develops the potential image on the intermediate image carrier; and
given a color change to a new color in the mixing device, measuring color values of a color of a residual developer fluid that remains after execution of the preceding print job and, via comparison of these color values with color values of the new color, determining whether the new color can be generated using the residual developer fluid of the preceding print job, and if this is the case, using the residual developer fluid to generate the new color, and if this not the case, first reducing a fill level in the mixing container to a residual quantity at a lower limit of a tolerance range for a sufficient inking for a following print job by adding carrier fluid, and using this residual quantity to generate the new color.

47. A method according to claim 46 in which a toner particle concentration in the mixing container is additionally reduced via addition of carrier fluid given the generation of the residual quantity.

48. A method according to claim 46 in which a suitability of the residual developer fluid for use in a mixture of the developer fluid of the new color is established via comparison of a chroma and a color angle of the residual developer fluid with a chroma and a color angle of the new color.

49. A method according to claim 48 in which the suitability of the residual developer fluid for mixture of the new color is present when its chroma is greater than or equal in comparison to the new color and the color angle is near color angles of neighboring primary colors of the customer color system.

50. A method according to claim 49 in which the color angle deviation Δh<60° is selected.

51. A method according to claim 46 in which, for successive printing of multiple colors, different colors to be printed are organized in a print order such that an optimal reusability of the residual developer fluid of a print job in the next print job is enabled.

52. A method according to claim 46 in which the developer station is cleaned without user intervention upon changing a color to be printed, even if the residual developer fluid of the previous print job cannot be used in the generation of the color of the next print job.

53. A method according to claim 46 wherein:
the developer fluid is generated in the mixing container arranged in the mixing device; and
the fill level in the mixing container is adapted via a fill level regulator to a required quantity of the customer-specific color of the running print job.

54. A method according to claim 46 in which given unsuitability of the residual developer fluid as a mixture component for generation of the color corresponding to the next print job, this is conveyed from the mixing container into a residual container.

55. A method according to claim 54 in which a fill level in the residual container is monitored in order to ensure a timely emptying.

56. A method according to claim 52 in which a continuous reduction of a concentration of colorant toner particles in the developer fluid flowing through the mixing device and the developer station occurs in a cyclical cleaning process.

57. A method according to claim 56 in which a concentration limit of the colorant toner particles up to which a cyclical cleaning process continues is defined in that a color shift of ΔE<3 according to the CIELAB system exists at this concentration for a subsequent customer-specific color.

58. A method according to claim 57 in which the cleaning of the developer station is implemented following a checking of a suitability of the developer fluid for mixing the developer fluid for the following print job, wherein the developer station is not in contact with the intermediate image carrier.

59. A method according to claim 58 in which in a first cleaning operation a cleaning fluid is conveyed through the mixing device and the developer station and is returned again to the mixing device.

60. A method according to claim 59 in which the cleaning fluid is directed through the mixing device and the developer station in a same manner as the developer fluid in the printing operation.

61. A device for developing a potential image of an image to be printed, said potential image being generated on an intermediate image carrier with selectable customer-specific colors comprising:
a mixing device that, dependent on a selectable color, has respective primary color concentrates with charged colorant toner particles in reservoirs and a reservoir with carrier fluid, a mixing station connected with the reservoirs, the mixing station generating developer fluid associated with a selected, customer-specific color from the primary color concentrates and the carrier fluid;
a developer station connected with the mixing device, the developer fluid being supplied to the developer station which develops the potential image on the intermediate image carrier in the customer-specific color, and at an outlet of the developer station a receptacle being arranged that accepts residual developer fluid remaining after the development of the potential image on the intermediate image carrier in the developer station; and
the receptacle being connected with a receiver that has a first 2-way valve arranged at an outlet of the receptacle, and via the first 2-way valve the receptacle can be connected with the mixing container or, via a second 2-way valve with a filter station or a residual container.

62. A device according to claim 61 in which the reservoirs are provided with primary color concentrates for 2 to 15 colors.

63. A device according to claim 62 in which the primary color concentrates have colorant toner particles and carrier fluid.

64. A device according to claim 63 in which the primary color concentrates have a large proportion by weight of colorant toner particles of 10 to 55%.

65. A device according to claim 63 in which color locations of the colorant toner particles of the various primary color concentrates exhibit a high chroma saturation and a graduated color hue.

66. A device according to claim 61 in which the mixing station mixing container has a mixing unit in order to generate the customer-specific developer fluid.

67. A device according to claim 61 in which an evaluation device is arranged at an outlet of the mixing station for calorimetric evaluation of the developer fluid.

68. A device according to claim 67 in which the evaluation device has a sensor for colorimetric evaluation of the developer fluid and a sensor to determine the proportion of colorant toner particles in the developer fluid.

69. A device according to claim 61 in which the developer station is designed to be pivoted away from the intermediate image carrier.

70. A device according to claim 61 in which a filter station is connected with the mixing container.

71. A device according to claim 61 in which a connection system is provided that connects the mixing device, the developer station and the receiver device with one another for transport of the developer fluid.

72. A device according to claim 61 wherein:
the developer station has a feed device, an applicator device and a cleaning device, the feed device being connected with the mixing device to transfer the developer fluid, the developer fluid being transferred from the feed device onto the applicator device and directed from the applicator device past the intermediate image carrier; and
the cleaning device cleaning the residual developer fluid remaining on the applicator device after the development of the potential images off of the applicator device and dispenses the fluid into the receptacle.

73. A device according to claim 61 in which a control unit is provided that exchanges control signals for operation with the mixing device.

74. A method to develop a potential image of an image to be printed with at lease one selectable customer-specific color using a developer fluid in an electrographic printing or copying device, the potential image being generated on an image carrier, comprising the steps of:
generating a customer-specific color for a print job as a developer fluid from primary color concentrates in a mixing container of a mixing device;
feeding the developer fluid to a developer station that develops the potential image on the image carrier; and
given a color change to a new color in the mixing device, measuring color values of a color of a residual developer fluid that remains after execution of the preceding print job and, via comparison of these color values with color values of the new color, determining whether the new color can be generated using the residual developer fluid of the preceding print job, and if this is the case, using the residual developer fluid to generate the new color, and if this not the case, first reducing a fill level in the mixing container to a residual quantity at a lower limit of a tolerance range for a sufficient inking for a following print job by adding carrier fluid, and using this residual quantity to generate the new color.
